(19) United States
(12) Patent Application Publication
(10) Pub. No.: US 2015/0211688 A1
(43) Pub. Date: Jul. 30, 2015

(54) LED Lighting System

(71) Applicant: LED SMART, INC., Edmonton (CA)

(72) Inventor: Xinxin Shan, Surrey (CA)

(21) Appl. No.: 14/167,830

(22) Filed: Jan. 29, 2014

(51) Int. Cl. F21K 99/00; F21V 19/00

(52) U.S. Cl. CPC F21K 9/175; F21V 19/004; F21Y 2103/003

(57) ABSTRACT

An LED lighting system has clips connecting components together electrically, including the end caps and LED drivers to replace the traditional soldered pins to connect different components or parts together. Thus, in one embodiment there is provided an LED lighting system, comprising a circuit board carrying one or more LEDs, two end caps with connecting pins and a LED driver. These components are connected together electrically via the clips.

### TECHNICAL FIELD

The present method relates in particular to a LED (light emitting diode) lighting system.

### BACKGROUND

Currently, in lots of applications, a LED Lighting System is assembled using a soldering method. This will include the connection between circuit boards, the connection to power connectors such as the pins or sockets, and the connection between LED boards to the LED driver. In this way, the operator has to be a very skilled worker. Depending on the complexity of the LED lighting system, the labor cost is a very important factor of the LED lighting system price. Another disadvantage of this method is the inconsistent quality obtained due to the manual operation. Also, because of lots of hands on work, the efficiency is very low.

### SUMMARY

There is another possible method to assemble the LED lighting system. This embodied method can help to improve the LED lighting system's quality and production efficiency, and reduce the cost of the product. There is thus provided clips on the components in the LED lighting system including the end caps and LED drivers to replace the traditional soldered pins to connect different components or parts together. Thus, in one embodiment there is provided an LED lighting system comprising a circuit board carrying one or more LEDs, two end caps with connecting pins, and a LED driver. These components are connected together electrically via the clips.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a 3-D view of a LED lighting system using single side contact clip assembly method.

FIG. 2 is a zoom view of the single-side contact clip assembly method.

FIG. 3 is a 3-D view of a LED lighting system using double side contact clip assembly method.

FIG. 4 is a zoom view of the double-side contact clip assembly method.

FIG. 5 is a 3-D view of a LED lighting system with external LED driver in the extrusion.

FIG. 6 is a 3-D view of the LED driver.

FIG. 7 is a section view of a LED lighting system.

FIG. 8 is another section view of a LED lighting system.

FIG. 9 is a section view of an end cap with power clip.

FIG. 10 is a section view of an end cap and LED PCB assembly.

FIG. 11 is a perspective view of an embodiment of an LED lighting system in which an internal LED driver is integrated with a PCB that carries LEDs.

### DETAILED DESCRIPTION

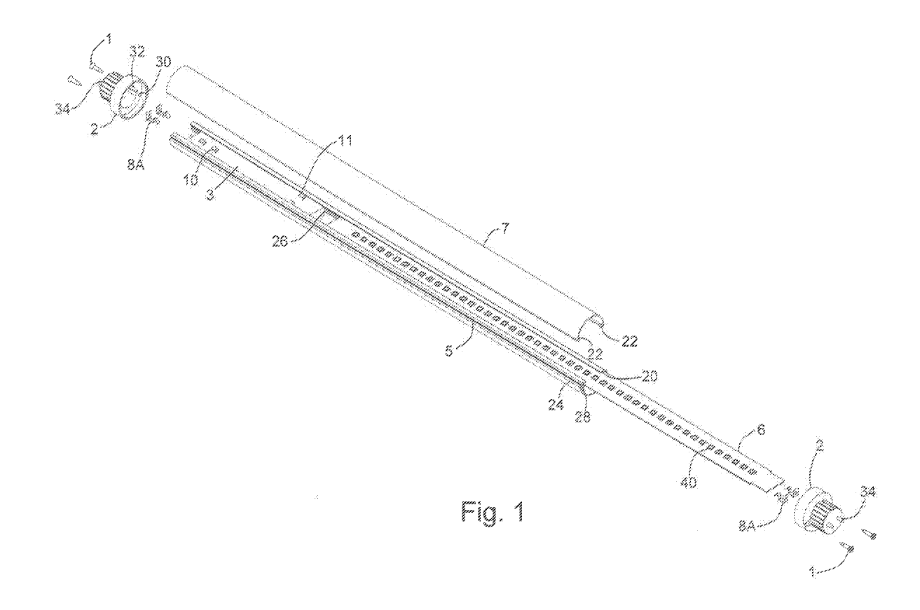

FIG. 1 shows an embodiment of an LED lighting system comprising a support structure or housing 5 that extends between first and second ends, and a circuit board 6 (PCB board for example) carrying one or more LEDs 40 with the housing 5 supporting the circuit board 6. The LEDs 40 form an array that is carried by the PCB board 6 and the LED array extends along the length of the housing 5. The PCB board 6 provides electrical power and control for the LEDs. In the example shown, the circuit board 6 is received in inwardly directed slots 20 running along the edges of the housing 5, so that the circuit board 6 may slide into the housing 5. The housing 5 may also be provided with a lens 7 that has inwardly directed edges 22 that engage and slide into outwardly directed slots 24 on the housing 5. The housing 5 may also be provided with end caps 2 that define the first and second ends in this embodiment. The LED lighting system includes an LED driver 3 that is secured in the housing 5 by laterally extending edges 26 on the power supply 3 that are received by slots 28 in the housing 5 below the slots 20 that receive the circuit board 6 that extend inwardly along the housing 5 between the first and second ends. In other embodiments, the LED driver 3 or components of the LED driver 3 may be incorporated into the circuit board 6.

The PCB board 6 is received in slots 30 in the respective end caps 2. The housing 5 is received with flanges 32 that extend around the end caps 2. The flanges 32 have an inwardly directed surface that has a profile that matches the outwardly facing surface of the housing 5, so that the end caps 2 may be press fit onto the housing 5. In an embodiment, the profile may be circular as shown. The screws 1 may be inserted through openings in the end caps 1 and screw into the walls of the housing 5 to secure the housing 5 within the end caps 2.

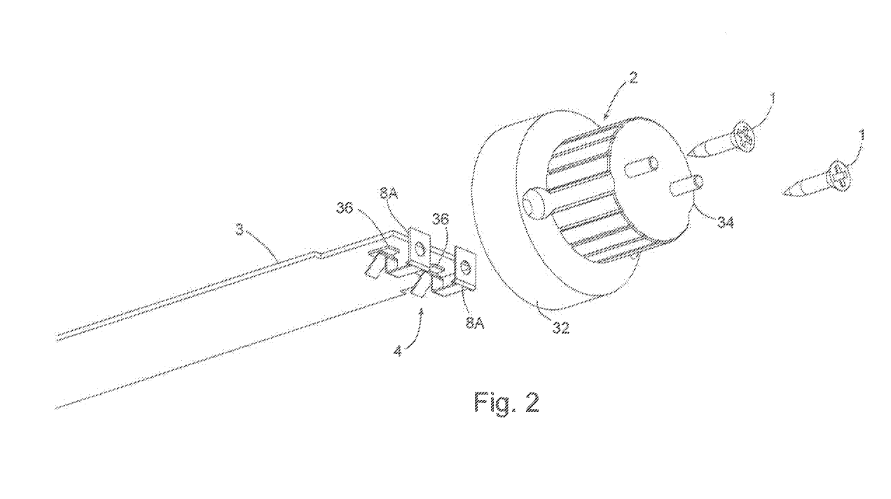

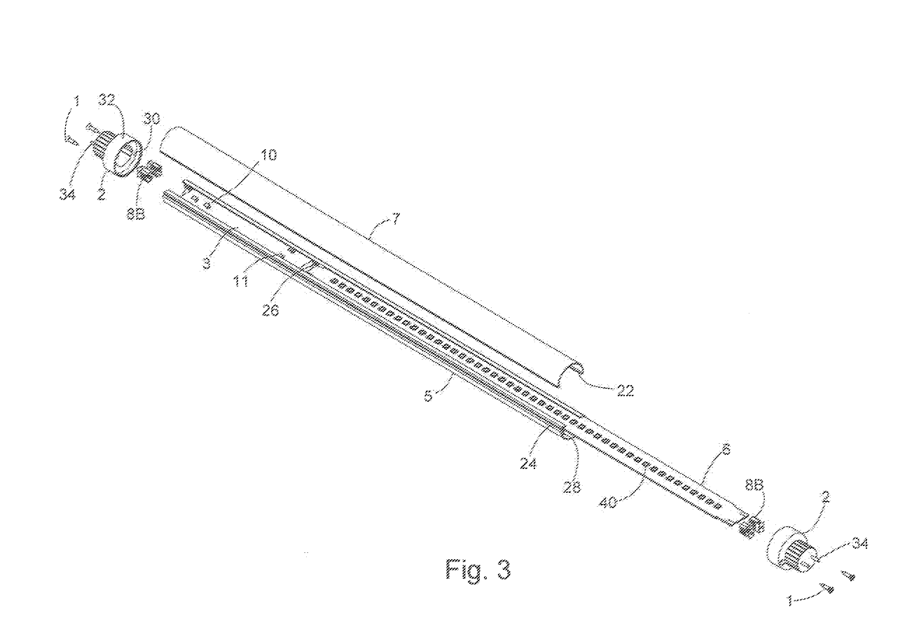

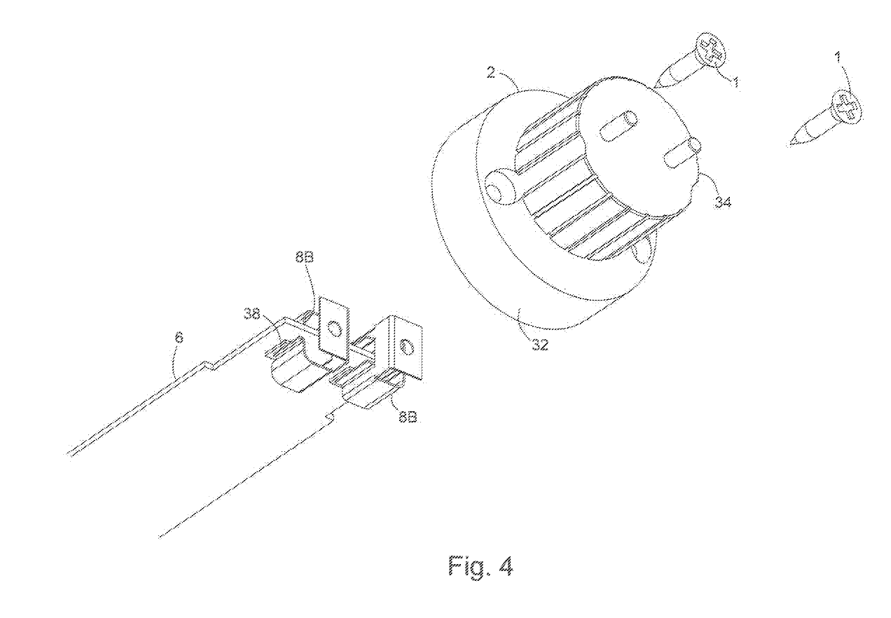

The LED lighting system is provided with power clips 8A (FIGS. 1 and 2) in one embodiment, and power clips 8B (FIGS. 3 and 4) in another embodiment, although in some embodiments other configurations may be used. Power clips 8A and 8B are fixed in the respective end caps 2 in communication with conventional pins or electrical socket connectors 34 on the end caps 2, where the power comes from. Corresponding power clips 4 are provided on the LED driver 3. The clips 4 are the input and output of the LED driver 3.

The power clips 8A, 8B are made of some electrically conductive flexible material, such as spring metal. When different components are getting in touch and need to electrically conduct, the clips have to touch another component tight enough.

FIG. 2 shows a zoom view of one embodiment using a power clip 8A with single side contact. Power clips 8A are fixed to the pins 34 on the end caps. The methods to fix the power clips 34 may include, but are not limited to, soldering or riveting. On the PCB board 6 there are two power pads 36 on one end. These power pads 36 are made of conductive material. They could be conductive material such as copper, or it can be just part of the PCB soldering pad, or solder on the PCB. When the pins 34 on the end caps 2 connect to the power socket, the electrical power will be provided to the PCB board 6 through the power clips 8A, 8B and power pads 34.

FIG. 3 shows another embodiment of the LED lighting system. In this embodiment, the power clips 8B connecting the power pins 34 and the PCB boards 6 are different from the embodiment of FIG. 1. FIG. 4 shows a zoom view of how to assemble the light with the new double side contact power clips 8B. In this method, there are power pads 38 on both sides of the PCB board 6. The power clips 8B are fixed to the power pins 34 on the end cap 2 individually. The power clips 8 contact the PCB boards on both sides when the end cap is installed. The electrical power will be provided to the PCB 6 through the power pins 34 and the power clips 8B and the power pads 34. Here the gap of the power clips 8B in the unstressed position should be a little bit smaller than the depth of the PCB 6 plus two layers of power pads 34. When the PCB 6 inserts into power clips 8B, it should be tight enough for the electrical circuit to work properly without making any sparks.

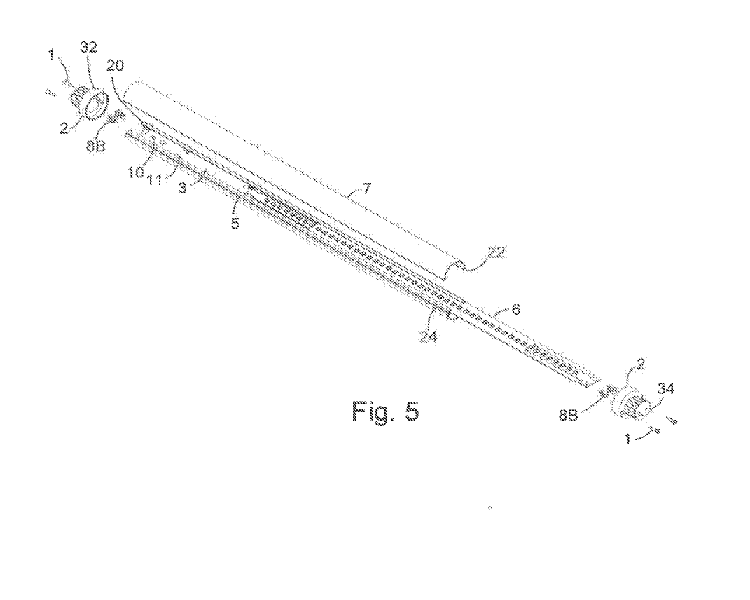

FIG. 5 shows an embodiment of the LED lighting system. The power pins 34 on end cap 2 connect to the external power source. The power clip 8B is fixed to the power pin 34. The LED driver 3 is in the body of extrusion 5. On LED driver 3 there are a pair of LED driver inlet clips 11 and a pair of LED driver outlet clips 10. The LED PCB 6 is inserted to the extrusion 5 on top of LED driver 3. During assembling, LED PCB 6 will be inserted into the power clips 8B (or 8A as the case may be) to receive power.

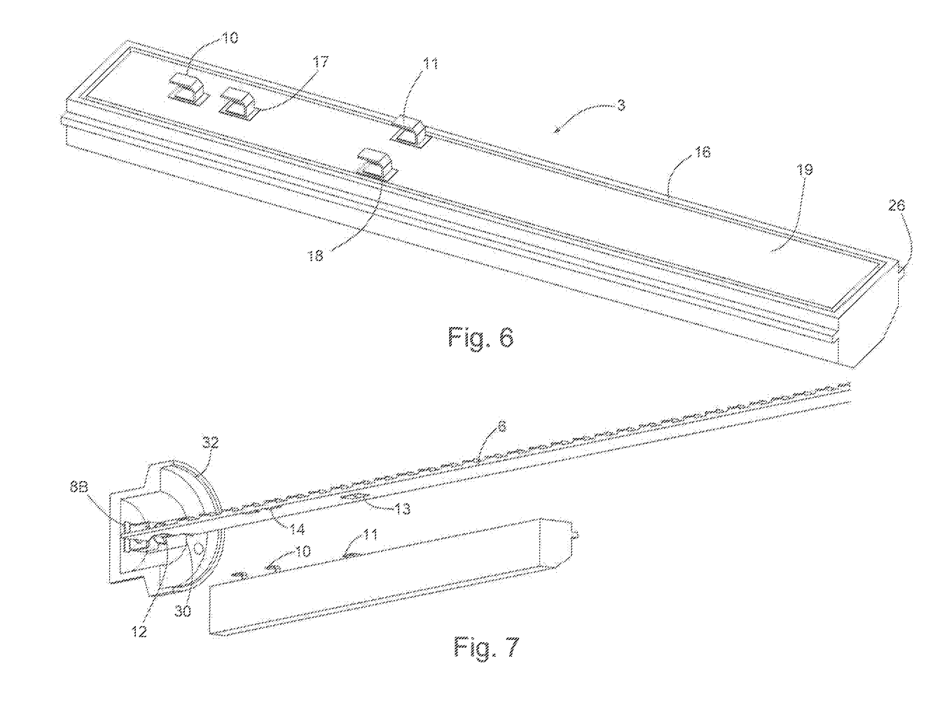

FIG. 6 shows how to attach the power clips 10 to LED driver 3. In this embodiment, the LED driver 3 includes a LED driver case 16 and LED driver PCB 19. The LED driver inlet clips 11 and LED driver outlet clips 10 are soldered to the PCB inlet solder pad 18 and PCB outlet solder pad 17 respectively.

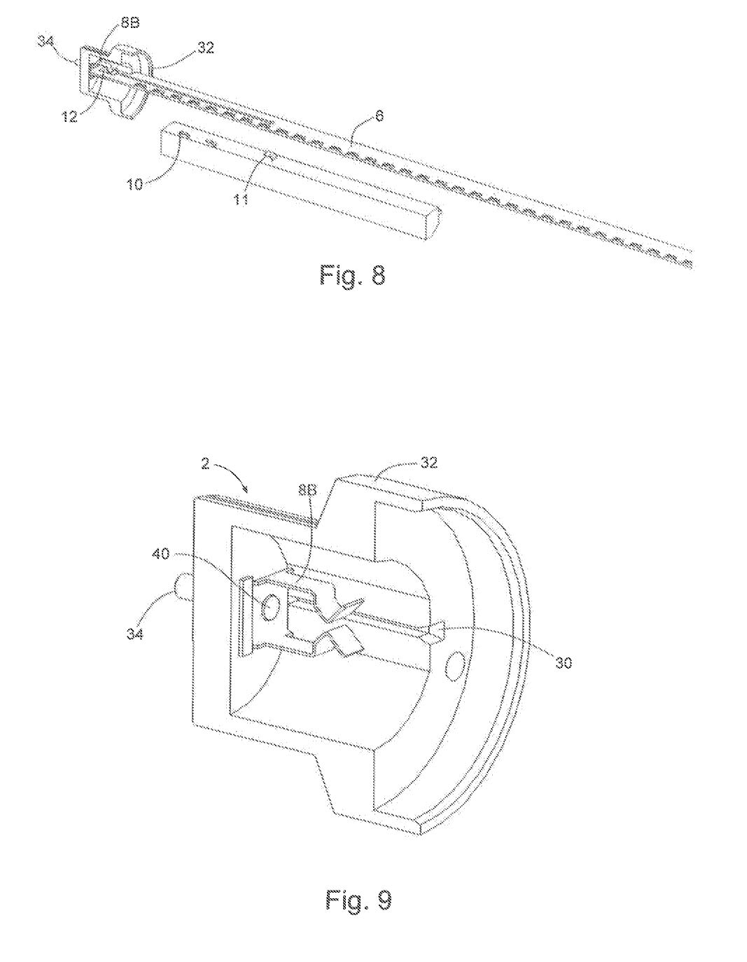

FIG. 7 and FIG. 8 show a section view of the LED lighting system. In this embodiment, the LED PCB 6 is inserted into power clips 8B, which get contact with PCB power inlet solder pad 12. The LED driver inlet clips 11 and LED driver outlet clips 10 on LED driver 3 will contact the PCB LED power inlet solder pad 13 and PCB power outlet solder pad 14 respectively after the assembling.

FIG. 9 shows a zoom view of the end cap 2 with the power clip 8B and power pin 34. In this embodiment, the power clip 8B is fixed to power pin using riveting method using rivet 40. The power clip 8B is made of conductive material to conduct the power from power pin 34.

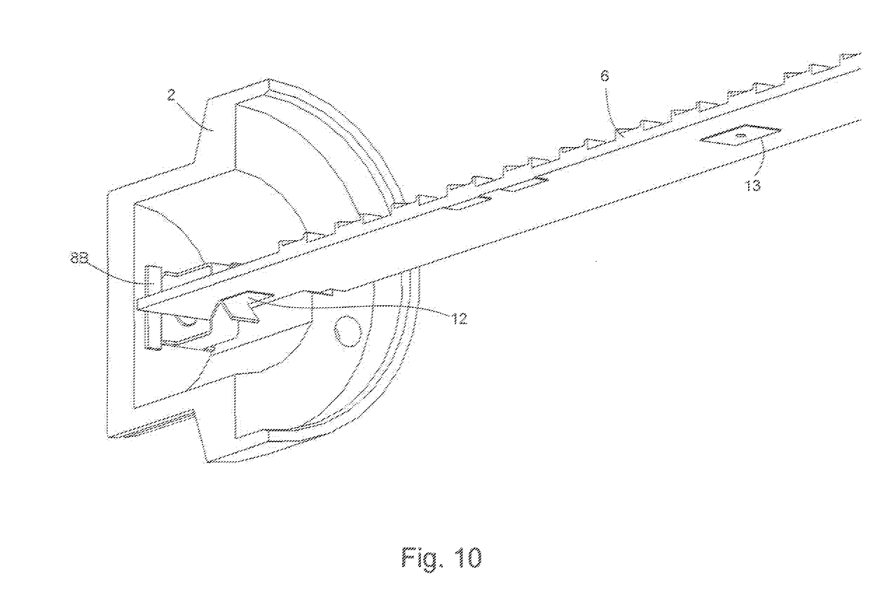

FIG. 10 shows how the end cap 2 and the LED PCB 6 are assembled together. The PCB 6 is inserted into the power clip 8B. The PCB power inlet solder pad 13 will get contact with the power clips 8B to conduct the power.

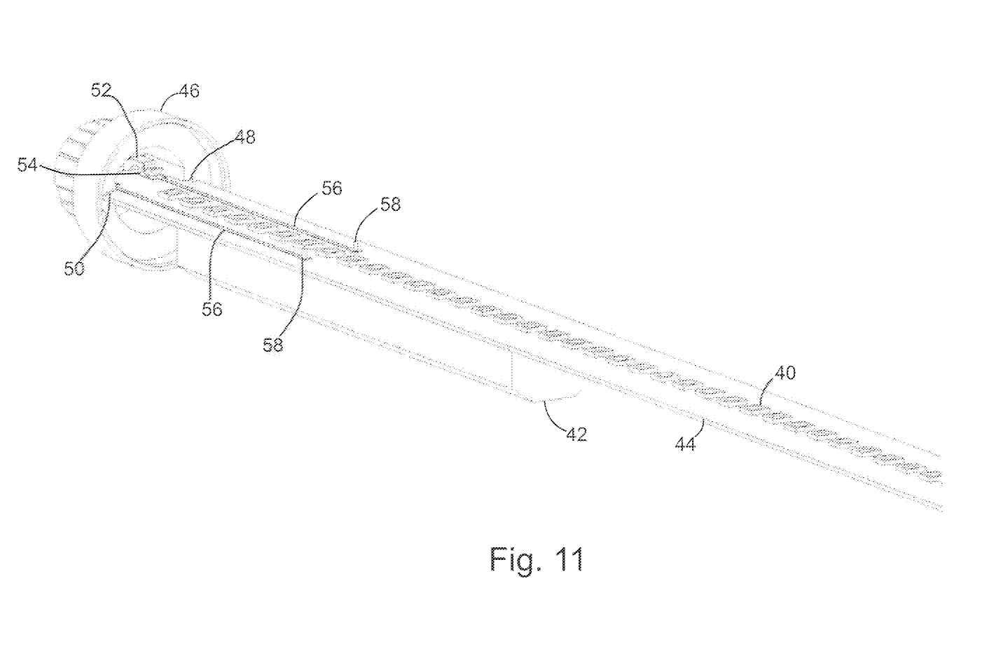

FIG. 11 shows an embodiment of an LED lighting system in which an LED driver 42 is integrated with a circuit board 44 that carries LEDs 40. In this embodiment, the LED lighting system is also provided at one end with an end cap 46 with slots 48 on either side that receive side edges 50 of the circuit board 44. A similar or identical end cap is provided at the other end of the circuit board 44. The circuit board 44 is also supported by a housing (not shown) similar to the housing 5 except that an additional set of slots, besides the slots for the circuit board 44, is not required (though may be present). An additional set of slots for the LED driver 42 is not required in the end cap 46 or housing since the LED driver 42 is made as part of the circuit board 44 or as a separate part otherwise secured directly to the circuit board 44 by any suitable means.

In this embodiment, clips 52 are provided within the end cap 46. The clips 52 communicate electrically with pins (not shown) that may be inserted in a conventional power supply receptacle. The clips 52 may be made in the same or like manner to the clips 8A and 8B, and may be single sided or double sided and may be made of spring metal. The clips 52 are arranged in the end cap 46 to press against electrically conducting input/output pads 54 on the circuit board 44. In this embodiment, the pads 54 are made as part of and/or otherwise communicate electrically with electrically conducting strips 56 on the circuit board 44. The conducting strips 56 communicate electrically with the LED driver 42, for example, through pins 58 formed in the circuit board 44, and thus provide power for the LED driver 42. The strips 56 may also be provided on the other side of the circuit board 44 or within the circuit board 44 or the power transport function of the strips 56 may be provided by other methods, such as a conducting element extending directly from the LED driver 42 to the clips 52.

The LED drivers 3 and 42 may provide all necessary drive functions for the LEDs 40, including regulating power supplied to the LEDs 40, using techniques known in the art. The LED drivers 3 and 42 may be provided as a single block, in multiple blocks in one location on the circuit board 44, or distributed across the circuit board 44, or some or all functions of the LED drivers 3 and 42 may be provided in the end caps 46. If all functions of the LED drivers 3 and 42 are carried out in the end caps 46, then the pads 54 may communicate directly with the LEDs 40 through circuit paths on the circuit board 44 that are made in conventional fashion.

Immaterial modifications may be made to the embodiments described here without departing from what is covered by the claims. In the claims, the word “comprising” is used in its inclusive sense and does not exclude other elements from being present. The indefinite article “a” before a claim feature does not exclude more than one of the features being present. Each one of the individual features described here may be used in one or more embodiments and is not, by virtue only of being described here, to be construed as essential to all embodiments as defined by the claims.

1. An LED lighting system comprising:
a support structure spanning between a first end and a second end;
at least one LED array extending along the support structure; and
clips connecting electrical units in the LED lighting system together electrically.

2. The LED lighting system of claim 1 in which at least the first end comprises electrical socket connectors, a circuit board is carried by the support structure and the clips include clips that provide an electrical connection between the electrical socket connectors and pads on the circuit board.

3. The LED lighting system of claim 2 further comprising a LED driver, the LED driver being carried by the support structure and being supplied power through the pads on the circuit board.

4. The LED lighting system of claim 3 in which the clips include clips that provide an electrical connection between the LED driver and the circuit board.

5. The LED lighting system of claim 3 in which the LED driver is integrated with the circuit board.

6. The LED lighting system of claim 2, in which the at least one LED array is provided on the circuit board.

7. The LED lighting system of claim 1 in which at least some of the clips are made of spring metal.

8. The LED lighting system of claim 1 in which the first and second ends comprise caps having electrical socket connectors, the LED array is carried by a circuit board, and at least some of the clips provide an electrical connection between the electrical socket connectors and the circuit board.

9. The LED lighting system of claim 1 in which at least some of the clips connect between a LED driver and an electrical circuit board that carries the at least one LED array.

10. The LED lighting system of claim 1 in which at least some of the clips connect between circuit boards.

11. The LED lighting system of claim 1 in which at least some of the clips connect to a circuit board on one side of the circuit board.

12. The LED lighting system of claim 1 in which at least some of the clips connect to a circuit board on both sides of the circuit board.

13. The LED lighting system of claims 2 in which the circuit board is received in slots in the support structure.

14. The LED lighting system of claim 4 in which the circuit board is received in first slots in the support structure and the LED driver is received in second slots in the support structure.

15. The LED lighting system of claim 2 in which the first end and the second end of the support structure each comprise caps and the circuit board is received in slots in the caps.

16. The LED lighting system of claim 1 further comprising an internal or external LED driver.
